(19) United States
(12) Patent Application Publication
(10) Pub. No.: US 2007/0096598 A1
(43) Pub. Date: May 3, 2007

(54) Drive device for ultrasonic linear motor

(75) Inventors: Shigeru Ichikawa, Sayama-shi (JP); Yuuichi Sube, Sayama-shi (JP); Eiji Murakami, Sayama-shi (JP)

Correspondence Address: BIRCH STEWART KOLASCH & BIRCH, PO BOX 747, FALLS CHURCH, VA, 22040-0747, US

(73) Assignee: HONDA MOTOR CO., LTD., Saitama (JP)

(21) Appl. No.: 10/579,193

(22) PCT Filed: Apr. 21, 2005
(86) PCT No.: PCT/JP05/08096

§ 371 Date: May 12, 2006

(30) Foreign Application Priority Data
May 12, 2004 (JP) 2004-142315

(51) Int. Cl. H02N 2/00

(52) U.S. Cl. 310/323.02

(57) ABSTRACT

This invention relates to a drive device of an ultrasonic linear motor having a rail (11, 42) and a base body (12, 44) and driving parts (20, 50) interposed between rail and base body. The base body is moved in a straight line with respect to the length direction of the rail by the driving parts. The driving parts are provided on left and right leg parts (12a, 44a) of the base body, and the load of the base body acts almost not at all on the driving part. The driving parts have ultrasonic vibrators (21,52) and rollers (25, 51) rotationally driven by the ultrasonic vibrators. The rollers are urged by urging means (22, 53) toward and into contact with guiding side faces (11b, 11c, 42b, 42c) of the rail, driving forces generated by the driving parts act on the guiding side faces of the rail, and the base body moves in the length direction of the rail.

### TECHNICAL FIELD

This invention relates to a drive device of an ultrasonic linear motor in which with the vibration of ultrasonic vibrators as a drive source a rail and a base body move relatively with respect to a length direction.

### BACKGROUND ART

An ultrasonic linear motor of this kind is made up of a base body having a piezoelectric device as a drive source in its center and having sliding parts at its ends, and a rail supporting the sliding parts of this base body. An ultrasonic linear motor in which the sliding parts of the base body are abutted with this rail and the base body moves relative to the rail is disclosed for example in JP-A-6-6989. The ultrasonic linear motor disclosed in this publication will be described on the basis of FIG. 10.

The ultrasonic linear motor shown in FIG. 10 is made up of a rail 101, a base body 103 made of an elastic material and placed on the rail 101, piezoelectric devices 104, 104 mounted on the top of the base body 103 with a predetermined spacing, and sliding parts 105, 105 provided on the left and right of the base body 103.

The base body 103 includes the piezoelectric devices 104, 104 and the sliding parts 105, 105. The base body 103 doubles as an ultrasonic vibrator 112.

Guiding of the base body 103 with respect to the rail 101 is carried out by the guide mechanism 110.

The guide mechanism 110 is made up of groove parts 106, 106 formed in the sides of the rail 101, a linear guide member 107 provided slidably along the groove parts 106, projections 108 projecting from the linear guide member 107, projections 109 projecting from the base body 103, and springs 111 extending between the projections 108 and the projections 109.

When a voltage having a predetermined frequency is applied to the piezoelectric devices 104, 104 provided on the base body 103, the piezoelectric devices 104, 104 vibrate. Vibration occurring at the left and right sliding parts 105, 105 causes the base body 103 (the ultrasonic vibrator 112) to move along the rail 101 in the length direction.

However, because the load of the base body 103 (the ultrasonic vibrator 112) is born by the sliding parts 105, 105, with use over a long period wear of the sliding parts becomes large. In particular, in an environment such as a factory where a lot of foreign matter such as dust floats around, there is the problem that with use over a long period wear proceeds quickly, and lifespan becomes short.

Consequently, maintenance such as regularly replacing the base body 103 (the ultrasonic vibrator 112) becomes necessary. Accordingly, an ultrasonic linear motor with superior durability has been awaited.

### DISCLOSURE OF THE INVENTION

The present invention provides a drive device of an ultrasonic linear motor in which a rail and a base body are driven movably relative to one another by a driving part interposed between the rail and the base body, the driving part including: at least a left-right pair of rollers making contact with side faces of the rail; at least a left-right pair of ultrasonic vibrators for applying a turning force individually to each of the pair of rollers; and urging means for urging the ultrasonic vibrators and the rollers toward the side faces of the rail.

Because in this invention the driving parts are interposed between the rail and the base body like this, the driving forces produced by the driving parts act from the base body toward the side faces of the rail. Because the urging means urge the ultrasonic vibrators and the rollers toward the side faces of the rail, by adjusting the urging force it is possible to set the urging force on the rail to an optimal value, and an optimal driving torque can be obtained. Also, because the ultrasonic vibrators constituting the drive source are provided left-right symmetrically about the width-direction center of the base body, the driving force can be made strong stably, the base body can be driven with good left-right balance, and the base body can be moved strongly and smoothly.

In the drive device of the invention, preferably, an ultrasonic vibrator and rollers and urging means are received en bloc in a holding frame and fitted to the base body via this holding frame, and the rollers are removably mounted to the holding frame. When the rollers are provided removably on the holding frame like this, even when as a result of use in an environment such as a factory where a lot of foreign matter such as dust floats around the frequency of replacement of rollers becomes high due to wear and deterioration, the rollers can be replaced easily. As a result, the maintainability of the rollers can be increased.

The rail preferably has an upper face for bearing the load of the base body and sloping side faces formed on its left and right sides, the base body has opposing faces facing the sloping side faces, and the rail is gripped by rollers provided on the opposing faces and making contact with the sloping side faces and by the bottom face of the base body. Because the rollers are directed diagonally upward into contact with the sloping side faces by the urging means like this and the load of the base body is born by the top face side of the rail, the rail is gripped by the rollers and the bottom face of the base body. Consequently, looseness of the base body with respect to the rail in the up-down direction and the left-right direction is prevented from arising.

In addition, because most of the load of the base body is born by the top face of the rail, the load of the base body does not readily act on the ultrasonic vibrators of the driving parts. As a result, wear of the ultrasonic vibrators of the driving parts is greatly reduced and the durability of the ultrasonic vibrators increases.

### BRIEF DESCRIPTION OF THE DRAWINGS

FIG. 1 is a sectional view showing a drive device of an ultrasonic linear motor according to a first embodiment of the invention;

FIG. 2 is a sectional view on the line 2-2 in FIG. 1;

FIG. 3 is a perspective view of one driving part of the first embodiment shown in FIG. 1;

FIG. 4A, FIG. 4B and FIG. 4C are operation views of the driving part shown in FIG. 3;

FIG. 5 is a perspective view showing a drive device of an ultrasonic linear motor according to a second embodiment of the invention;

FIG. 6 is a sectional view on the line 6-6 in FIG. 5;

FIG. 7 is an exploded perspective view of a driving part of the second embodiment shown in FIG. 6;

FIG. 8 is a view illustrating loads of a driving part on a rail of the second embodiment shown in FIG. 6;

FIG. 9 is a sectional view showing a variation of the drive device of the second embodiment shown in FIG. 6; and

FIG. 10 is a view showing an ultrasonic linear motor of related art.

### BEST MODE FOR CARRYING OUT THE INVENTION

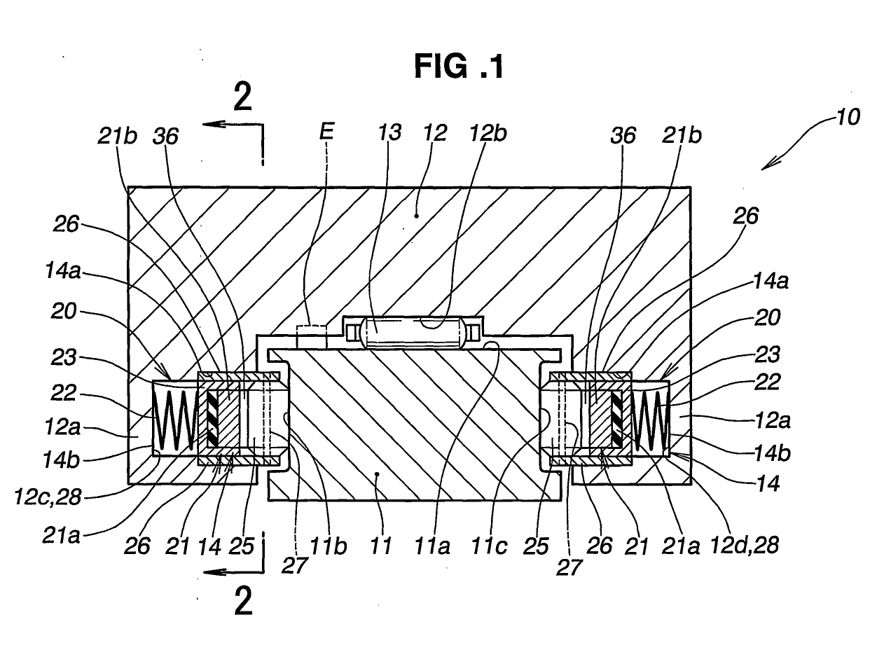

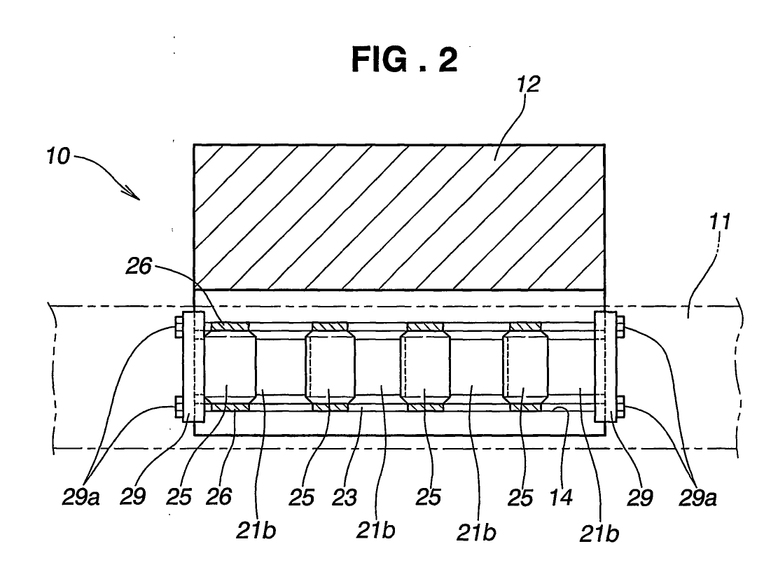

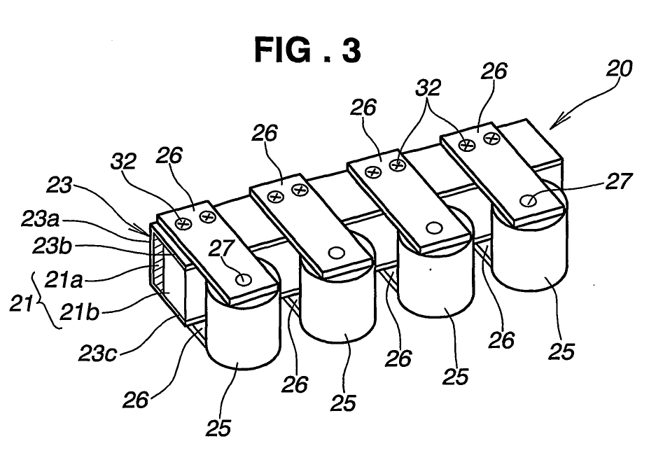

FIG. 1, FIG. 2 and FIG. 3 show a linear motor drive device 10 and driving parts 20 according to a first embodiment of the invention. The drive device 10 of the first embodiment is made up of a rail 11, a base body 12 movably mounted on the rail 11, and left and right driving parts 20, 20 provided on the base body 12.

The base body 12 is sectionally U-shaped and has left and right leg parts 12a, 12a and surrounds the top face 11a and the side faces 11b, 11c of the rail 11 and is loaded on the top face 11a of the rail 11 via multiple bar-shaped bearings 13. The leg parts 12a, 12a of the base body 12 have holding holes 14, 14 for holding the driving parts 20, 20. The holding holes 14, 14 have open sides facing the side faces 11b, 11c of the rail and are formed in the length direction of the base body 12. The holding holes 14 are made up of first holding holes 14a positioned in the inner sides of the leg parts 12a of the base body 12 and second holding holes 14b positioned nearer the outer side faces of the leg parts 12a.

The multiple bearings 13 are disposed on the bottom face 12b of the base body so as to have a predetermined spacing in the length direction, and make the movement of the base body 12 relative to the rail 11 smooth. The rail 11 bears the load of the base body 12 on the rail top face 11a via the bearings 13.

Although the ultrasonic linear motor drive device 10 of the first embodiment shown in FIG. 1 and FIG. 2 is an example wherein driving parts 20, 20 are provided on a base body 12 and the base body 12 is movable with respect to the rail 11, alternatively the base body 12 may be fixed and the rail 11 made movable with respect to the base body 12. That is, the rail 11 and the base body 12 may be constructed so as to be movable relative to each other.

The driving parts 20, 20 create driving forces for driving the base body 12. These driving parts 20, 20 are interposed between the left and right side faces 11b, 11c of the rail 11, which constitute guide faces, and the leg parts 12a, 12a of the base body 12. Each of the driving parts 20 has an ultrasonic vibrator 21, an urging member 22, and multiple rollers 25.

Each ultrasonic vibrator 21 is made up of a piezoelectric device 21a and a vibrating elastic member 21b, and produces a vibration and applies a turning force to the rollers 25. This ultrasonic vibrator 21 is received in a sectionally U-shaped holder member 23 as shown in FIG. 3. The piezoelectric device 21a and the vibrating elastic member 21b are affixed and disposed so that the piezoelectric device 21a is on the side of the side wall 23a of the holder member 23.

The holder members 23 are received in the first holding holes 14a of the holding hole parts 14 formed in the leg parts 12a of the base body 12. The urging members 22, 22 are interposed between the holder members 23 and opposing faces 12c, 12d (base body side faces 28) of the base body forming the second holding hole parts 14b. The holder members 23 are urged by the urging members 22 so that they press against the guiding side faces 11b, 11c of the rail 11.

Each of the holder members 23 has multiple support plates 26 fixed cantilever-style to an upper wall 23b and a lower wall 23c by flush screws 32, 32 as shown in FIG. 3. The support plates 26 extend toward the guiding side faces 11b, 11c of the rail 11 so as to project from the edges of the upper wall 23b and lower wall 23c.

The rollers 25 are rotatably mounted between the upper and lower support plates 26, 26 on shaft members 27. These rollers 25 can be removed from the upper and lower support plates 26, 26 by the flush screws 32, 32 being removed. That is, the rollers 25 are removable and replaceable with respect to the holder members 23. The rollers 25 are pressed into contact with the guiding side faces 11b, 11c of the rail 11 by the urging means 22 via the holder members 23. Accordingly, the base body 12 moves in a straight line along the guiding side faces 11b, 11c of the rail 11 on the multiple rollers 25 rotating with the vibration of the left and right ultrasonic vibrators 21, 21 as drive sources.

The holder members 23, 23 holding the ultrasonic vibrators 21, 21 are slidable with respect to the first holding hole parts 14a but are stopped by stoppers 29, 29 provided at the length-direction ends of the base body 12 as shown in FIG. 2. The stoppers 29, 29 are fixed to the ends of the base body 12 by multiple bolts 29a.

As explained above, on the rail 11, the face that bears the load of the base body 12 and the faces that make the base body 12 driveable are different. In other words, the load of the base body 12 is just supported by the rail top face 11a via the multiple bearings 13, and this load does not act on the guiding side faces 11b, 11c of the rail 11.

The reference letter E denotes an encoder for detecting the position of the base body 12 with respect to the rail 11.

The material of the rollers 25 is preferably steel, but there is no limitation to this and alternatively they may be aluminum or a resin material.

Although in this embodiment as the urging means 22 for urging the ultrasonic vibrators 21 the example of springs has been shown, they may alternatively be elastic members such as rubber members or resin members.

Although in the first embodiment an example has been shown wherein the holder member 23 having received the ultrasonic vibrator 21 is fitted directly in the holding hole 14 formed in the base body 12, alternatively a sectionally U-shaped holding frame 54, which will be described as a second embodiment with reference to FIG. 6, may be interposed between as it is assembled to the holding hole 14.

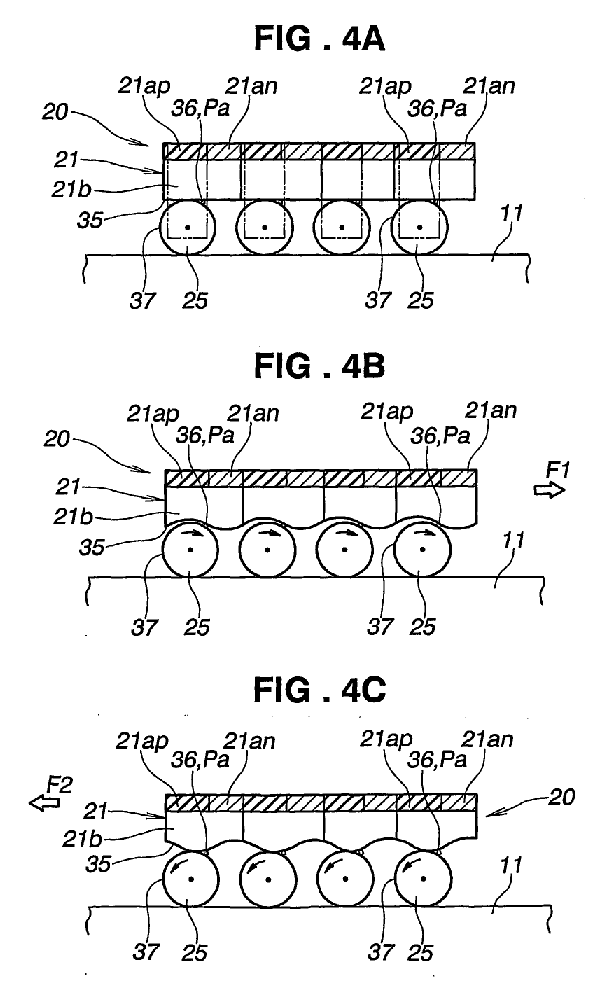

A piezoelectric device 21a for forward use and a piezoelectric device 21a for reverse use are combined to make one segment. As shown in FIG. 4A, the ultrasonic vibrator 21 is made up of four segments, and in FIG. 2 vibrating elastic members 21b, 21b, 21b, 21b constituting four segments are shown. Four rollers 25 are provided so as to be adjacent to the vibrating elastic members 21b, 21b, 21b, 21b constituting four segments. The ultrasonic vibrators 21 are connected to a control circuit not shown in the drawings.

Although in the example shown in FIG. 1 an example in which the ultrasonic vibrators 21 are mounted to the base body 12 via holder members 23 has been shown, alternatively the ultrasonic vibrators 21, 21 may be fitted in a base body 12 that doubles as a holding frame with the left and right leg parts 12a, 12a of the base body 12 as the holding frame, and the rollers 25 rotatably mounted adjacent to the respective ultrasonic vibrators 21, 21.

When a single-phase a.c. voltage is applied to an ultrasonic vibrator 21, the ultrasonic vibrator 21 vibrates in the form of a wave, and an elliptical motion accompanying this vibration and the progress of the wave arises. The rollers 25 are rotated by this elliptical motion of the ultrasonic vibrator 21. The direction of the rotation of the rollers 25 is made forward or reverse by the direction of the single-phase a.c. voltage applied to the piezoelectric devices 21a (see FIG. 1) being changed via the control circuit not shown.

The driving part 20 shown in FIG. 3 drives the base body 12 shown in FIG. 1.

Because as explained above the rollers 25 are removable and replaceable with respect to the holder members 23 holding the ultrasonic vibrators 21, when the device is used in an environment such as a factory where a large amount of foreign matter such as dust floats around, even if wear and deterioration of the rollers 25 becomes severe and the frequency of replacement of the rollers 25 becomes high, they can be replaced easily. As a result, the maintainability of the rollers 25 can be greatly increased.

Next, the operating principle by which the multiple rollers 25 adjacent to the ultrasonic vibrators 21 rotate will be explained, on the basis of FIG. 4A, FIG. 4B and FIG. 4C.

As mentioned above, in the first embodiment, the piezoelectric devices 21a of the ultrasonic vibrator 21 constitute four segments. One segment has two polarized regions 21ap, 21an.

Rectangular projecting parts 36 are provided on the surface 35 of the vibrating elastic member 21b, made up of four segments, of the ultrasonic vibrator 21. The reference symbol Pa shows the positions of the projecting parts 36 provided on the ultrasonic vibrator 21.

FIG. 4A shows a state in which no a.c. voltage is being applied to the segments of the ultrasonic vibrator 21, i.e. the two polarized regions 21ap, 21an of the piezoelectric devices 21a. In this case, the ultrasonic vibrator 21 does not vibrate and no rotational vibration arises in the projecting parts 36 provided on the surface 35 of the ultrasonic vibrator.

As shown in FIG. 4B, when a single-phase a.c. voltage is applied to the polarized region 21an of each of the segments of the ultrasonic vibrator, the surface 35 of the ultrasonic vibrator starts to vibrate, and a wavelike face forms. A counter-clockwise elliptical rotational vibration Pb accompanying the progress of the waveform arises in the projecting parts 36 provided on the surface 35. Because the projecting parts 36 are in contact with the circumferential faces 37 of the rollers 25, a clockwise turning force is applied to the rollers 25 by this rotational vibration Pb. Consequently, rotation of the rollers 25 causes a force F1 toward the right in FIG. 4B to act on the driving part 20.

As shown in FIG. 4C, when a single-phase a.c. voltage is applied to the other polarized region 21ap of each of the segments of the ultrasonic vibrator, the surface 35 of the ultrasonic vibrator vibrates in the form of a wave. The phase of the waveform produced in the surface 35 of the ultrasonic vibrator is the opposite phase to that of the waveform shown in FIG. 4B. At the projecting parts 36 provided on the surface 35, a clockwise elliptical turning vibration Pc arises accompanying the progress of the waveform. Consequently, the projecting parts 36 cause a counter-clockwise driving force to be applied to the rollers 25. This driving force on the rollers 25 causes a force F2 toward the left in FIG. 4C to act on the driving part 20.

Thus, with the drive device of this embodiment, the turning direction F1, F2 of the rollers 25 can be changed just by the polarized regions 21an, 21ap of the piezoelectric devices 21a to which the single-phase a.c. voltage is applied being switched.

Because as shown in FIG. 1 the urging members 22, 22 are provided between the opposing faces 12c, 12d of the base body 12 and the holder member 23 on which the rollers 25, 25 are mounted, the urging force of the rollers 25, 25 on the rail 11 is set to an optimal value. As a result, by means of the driving torque created by the ultrasonic vibrator 21 the base body 12 can provide an optimal driving torque via the rollers 25, 25.

Because the ultrasonic vibrators 21 constituting the drive sources are mounted so as to face the rail 11 orthogonally to the axial direction, the driving forces can be strengthened and the base body 12 can be driven with good left-right balance. As a result, strong and smooth movement of the base body 12 can be obtained.

Because the load of the base body 12 on the rail 11 is made up of the vertical load supported by the rail top face 11a and the urging forces of the urging members 22 of the driving part 20 on the guiding side faces 11b, 11c of the rail 11, most of the load of the base body 12 acts on the bottom face 12b of the base body 12 only, and the load of the base body does not readily act on the ultrasonic vibrators 21 of the driving units 20. Consequently, there is the merit that an unnecessary burden does not act on the ultrasonic vibrators 21. As a result, the durability of the ultrasonic vibrators 21 increases.

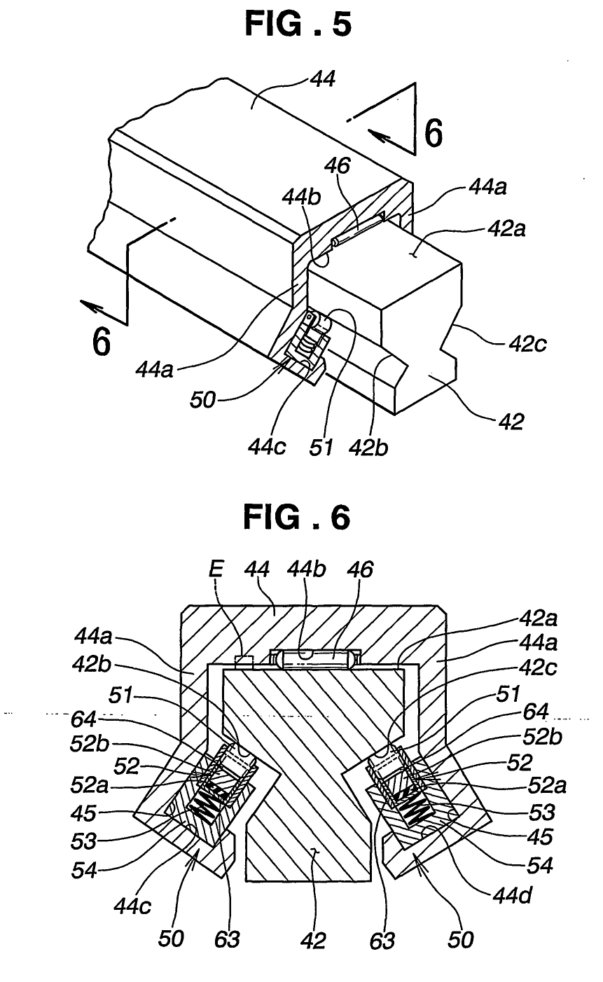

FIG. 5 to FIG. 8 show a drive device of an ultrasonic linear motor according to a second embodiment.

Like the first embodiment, this linear motor is made up of a rail 42, a base body 44 and driving parts 50. The base body 44 is sectionally U-shaped with leg parts 44a, 44a at its sides. The leg parts 44a are formed so as to project outward and have holding hole parts 45 for holding the driving parts 50 in their inner side faces. Multiple bar-shaped bearings 46 are interposed between the top face 42a of the rail 42 and the bottom face 44b of the base body 44, and the base body 44 can move smoothly with respect to the rail 42. The side faces of the rail 42 have sectionally V-shaped guide grooves formed in them, and have left and right sloping side faces 42b, 42c of these guide grooves sloping downward. The driving parts 50, 50 are interposed between these sloping side faces 42b, 42c and opposing faces 44c, 44d (see FIG. 6) forming the holding hole parts 45 formed in the left and right leg parts 44a, 44a of the base body 44 facing the sloping side faces 42b, 42c.

In the figures, stoppers mounted at the ends of the base body 44 for fixing the driving parts 50 have been omitted.

As shown in FIG. 6, the rail 42 is gripped by the bottom face 44b of the base body 44 and left and right rollers 51, 51 of the driving parts 50, 50 mounted on the base body 44.

An ultrasonic vibrator 52 is made up of piezoelectric devices 52a and vibrating elastic members 52b, and has multiple segments as in the first embodiment. The piezoelectric devices 52a are made up of piezoelectric devices for forward and for reverse. Holder members 63, 63 receive the ultrasonic vibrators 52, 52 and have removable rollers 51, 51 in the same way as in the first embodiment.

Sectionally U-shaped holding frames 54, 54 are fitted in the holding hole parts 45, 45. The holding frames 54, 54 hold the holder members 63, 63 together with urging members 53, 53. The urging members 53, 53 urge the rollers 51, 51 via the holder members 63, 63 into contact with the sloping side faces 42b, 42c. That is, the holding frames 54, 54 have the function of holding the rollers 51, 51, the ultrasonic vibrators 52, 52, the urging members 53, 53 to the base body 44.

Because the base body 44 grips the rail 42 with the urging forces of the urging member 53, 53 urging the rollers 51, 51 to make contact facing diagonally upward with the sloping side faces 42b, 42c formed on the left and right side faces of the rail 42 and the base body 44 load acting on the rail top face 42a via the bearings 46, 46 like this, the occurrence of up-down and left-right looseness of the base body 44 with respect to the rail 42 is prevented without any other members being added. As a result, there is the merit that the number of parts can be reduced.

Also, because the driving parts 50 including the ultrasonic vibrators 52 constituting the drive sources for moving the base body 44 are provided on the inner sides of the leg parts 44a, 44a of the base body 44, the drive sources can be disposed in a compact way. For example, whereas a drive mechanism made up of a ball and screw normally has a complicated mechanism and takes up space and is heavy, a drive mechanism of this kind becomes unnecessary. As a result, there is the merit that it is possible to make the drive mechanism light, compact and simple.

Although in the second embodiment an example was shown wherein the base body 44 was made movable with respect to the rail 42, as in the first embodiment the base body 44 may alternatively be fixed and the rail 42 made movable with respect to the base body 44.

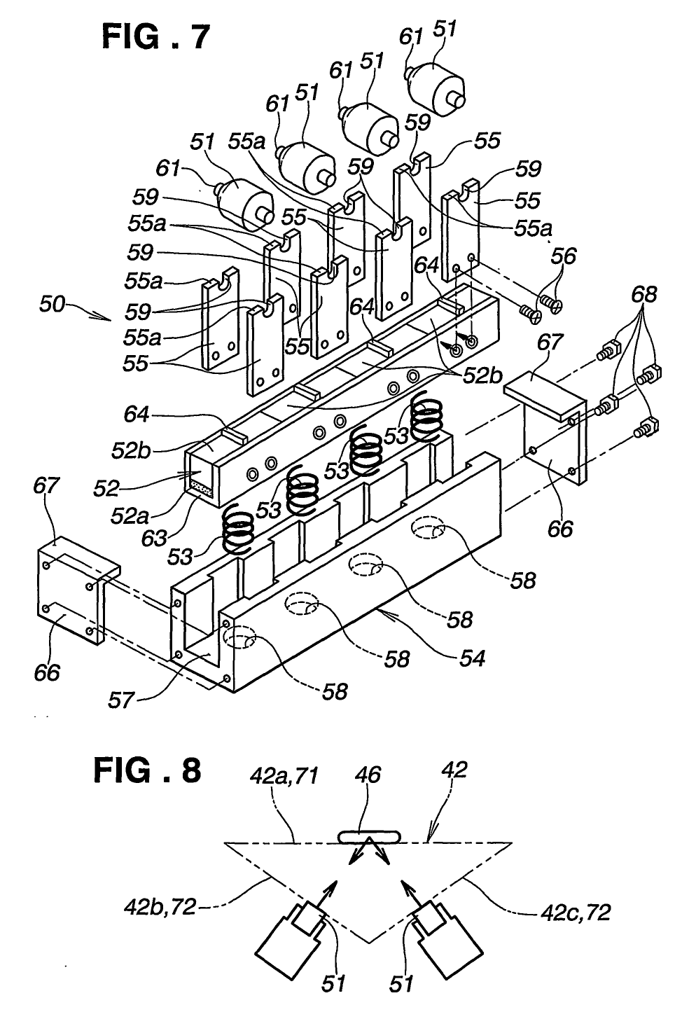

FIG. 7 shows a driving part 50 of the second embodiment shown in exploded perspective view.

Referring to FIG. 7, an ultrasonic vibrator 52 divided into four segments is received in a holder member 63. Support plates 55, 55 are fixed with flush screws 56, 56 to side faces of the holder member 63 in correspondence with the segments. Four urging members 53, 53 are disposed in four recesses 58 formed in the bottom 57 of the sectionally U-shaped holding frame 54. The holder member 63 is disposed on these urging members 53, and the four rollers 51 are supported on the upper ends 55a, 55a of the support plates 55, 55.

The rollers 51 have shaft members 61 and are rotatable with respect to the shaft members 61. Semi-circular shaft supporting parts 59, 59 are formed in the upper ends 55a, 55a of the support plates 55, 55, and the shaft members 61, 61 are supported on the shaft supporting parts 59, 59 and the rollers 51 thereby removably supported on the support plates 55.

A projecting part 64 is provided on each of the segments of the ultrasonic vibrator 52, and the projecting parts 64 are disposed so as to make contact with the rollers 51 as shown in FIG. 6.

Stoppers 66, 66 for stopping the holder member 63 from flying out of the holding frame 54 by more than a predetermined amount due to the urging members 53 are provided at the ends of the holding frame 54. The stoppers 66, 66 have retaining flanges 67, 67 projecting toward each other. The holder member 63 and the ultrasonic vibrator 52 are stopped from flying out by these retaining flanges 67, 67. The stoppers 66, 66 are fixed to the ends of the holding frame 54 by multiple bolts 68.

Although in the second embodiment shown in FIG. 6 and FIG. 7 an example is shown in which the support plates 55, 55 are mounted on the holder member 63, it is also possible to make a single part by providing the support plates 55, 55 integrally on the holding frame 54 side. In this case, the rollers 51 are removable and replaceable with respect to the holding frame 54.

When the rollers 51, 51 are provided removably with respect to the holding frame 54 like this, in use in an environment such as a factory where a large amount of foreign matter such as dust floats around, even if due to wear and deterioration the frequency of replacement becomes high, the rollers 51, 51 can be replaced easily. As a result, the maintainability of the rollers 51, 51 can be greatly increased.

Although in the second embodiment the shaft members 61 of the rollers 51 were supported on shaft supporting parts 59, 59, alternatively circular holes may be formed in the upper parts of the supporting members as shaft supporting parts, and the shaft members 61 inserted into these holes.

Although in the embodiment shown in FIG. 7 an example was shown wherein the number of urging members 53, 53 for urging the ultrasonic vibrator 52 was made four, it may alternatively be two or three, and the number may be set freely. Also, when elastic rubber is used as the urging members 53, 53 just one may be used.

FIG. 8 is a schematic view illustrating the loads acting on the rail 42 from the base body. The rail 42 has been drawn as an inverted isosceles triangle with the sloping side faces 42b, 42c of the rail 42, which are faces that bear loads, made sloping sides 72, 72, and the rail top face 42a made a top side 71.

As a result of the force of the load of the base body 44 shown in FIG. 6 acting on the upper face 71, which is the rail top face 42a, through the bearings 46 and the urging forces of the left and right rollers 51, 51 acting on the left and right sloping sides 72, 72 due to the urging members 53, 53 shown in FIG. 7, a stable force acts on the rail 42. Consequently, the base body 44 has good left-right balance and coupled with the bearings 46 moves smoothly with respect to the rail 42 without looseness arising.

Also, by the urging force of the urging members 53, 53 being adjusted an optimal pressing force (urging force) of the rollers 51, 51 on the sloping sides 72, 72 can be obtained, and an optimal driving force on the base body 44 can be secured.

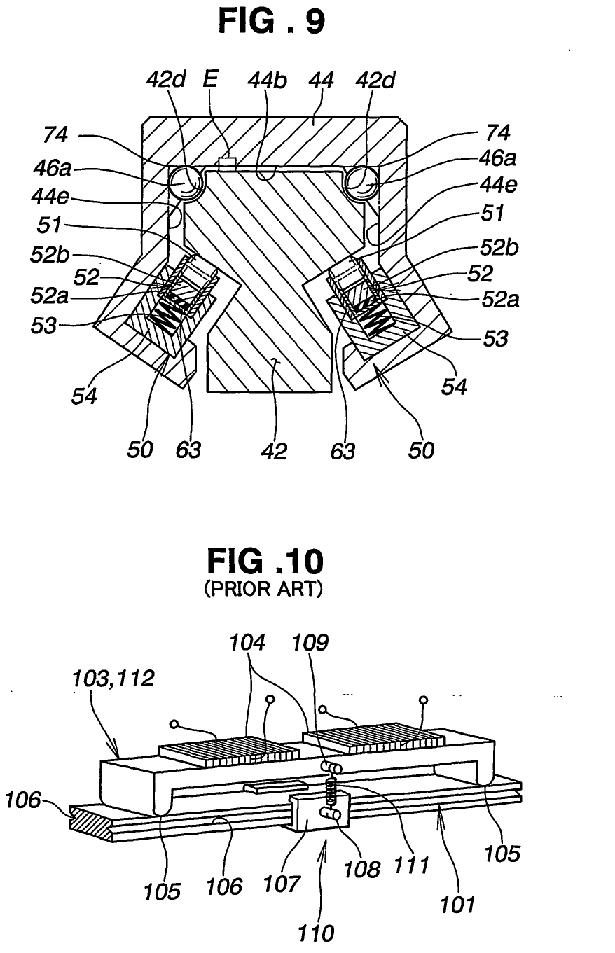

FIG. 9 shows a variation of the ultrasonic linear motor drive device of the second embodiment shown in FIG. 6. Parts the same as in the second embodiment of FIG. 6 have been given the same reference numerals and their description will be omitted. The point that differs from the second embodiment shown in FIG. 6 is that instead of bar-shaped bearings 46 provided in the center of the bottom face 44b of the base body, ball-shaped bearings 46a, 46a are provided at the corners of the bottom face 44b of the base body. Specifically, ball-shaped bearings 46a, 46a are provided at or near the points of intersection 74, 74 of the bottom face 44b of the base body with the inside faces 44e, 44e of the left and right leg parts 44a, 44a of the base body 44. The rest of the construction is the same as in the second embodiment shown in FIG. 6.

Thus, in the variation shown in FIG. 9, because bearings 46a, 46a are provided at the width-direction ends of the base body bottom face 44b, the base body 44 is supported at four locations, the load of the base body 44 being born at the top left and right by concave parts 42d, 42d formed in the left and right corners of the rail top face 42a and by the left and right rollers 51, 51, and consequently the occurrence of looseness is better prevented and the base body 44 can move smoothly with respect to the rail 42. And, the load burden on the rollers 51, 51 is also lightened.

### INDUSTRIAL APPLICABILITY

As described above, this invention can be used optimally in parts processing and assembly steps in a factory where a large amount of foreign matter such as dust floats around, in robot hands and jigs of production equipment used in carrying work to processing machines and assembly machines and attaching and removing workpieces, and is also usable in ordinary mechanical equipment such as construction machines and agricultural machines, and can also be used in automobiles and electrical appliances.

1. A drive device of an ultrasonic linear motor in which a rail and a base body are driven movably relative to one another by a driving part interposed between the rail and the base body, the driving part comprising:
at least a left-right pair of rollers making contact with side faces of the rail;
at least a left-right pair of ultrasonic vibrators for applying a turning force individually to each of the pair of rollers; and
urging means for urging the ultrasonic vibrators and the rollers toward the side faces of the rail.

2. A drive device according to claim 1, wherein the ultrasonic vibrators and the rollers and the urging means are received en bloc in a holding frame and fitted to the base body via the holding frame, and the rollers are removably mounted to the holding frame.

3. A drive device according to claim 1, wherein the rail has an upper face for bearing the load of the base body and sloping side faces formed on its left and right side faces, the base body has opposing faces facing the sloping side faces, and the rail is gripped by the rollers, which are mounted on the opposing faces and make contact with the sloping side faces, and a bottom face of the base body.
